(19) United States
(12) Patent Application Publication
(10) Pub. No.: US 2011/0011608 A1
(43) Pub. Date: Jan. 20, 2011

(54) POWER TOOL

(76) Inventor: Dietmar Saur, Gomaringen (DE)

Correspondence Address: MICHAEL J. STRIKER, 103 EAST NECK ROAD, HUNTINGTON, NY, 11743, US

(21) Appl. No.: 12/089,080

(22) PCT Filed: Aug. 25, 2006
(86) PCT No.: PCT/EP06/65691

§ 371 Date: Sep. 20, 2010

(30) Foreign Application Priority Data
Oct. 4, 2005 (DE) 10 2005 047 353.9

(51) Int. Cl. B25D 17/24; B25F 5/02

(52) U.S. Cl. 173/162.2

(57) ABSTRACT

The invention relates to an electric machine tool, in particular, having the construction of a pistol, comprising a drive unit (10) and a transmission unit (11). At least the drive unit (10) is mounted on an intermediate flange and is provided with a toothed shaft (14) in order to drive a drive train. According to the invention, the intermediate flange is distributed on the drive side and the transmission side of the bearing bridge element (12, 13), which are connected together via a vibration dampening device (15).

### PRIOR ART

The invention is based on a power tool as recited in the preamble to claim 1.

In power tools, particularly in hand-guided drills and rotary hammers, vibrations are generated, in particular by an impact mechanism, which cause a user to tire more quickly and reduce the grasping force that the user is able to exert. Oscillations that are transmitted from a machining point via the machining tool can amplify such vibrations. It is known to reduce such vibrations and oscillations, for example by providing grips that are partially covered with rubber. A vibration damping achieved in this way is often insufficient.

In power tools with a pistol-grip design, it is particularly problematic to achieve a vibration damping because devices of this kind have a compact design in which a drive axis is oriented axially parallel to an axis of a spindle and of one or more intermediate shafts. Percussion drills and rotary hammers, for example, have such a design. These machines have an impact mechanism for shattering stone and as a result, particularly powerful vibrations are generated during their use. Devices currently on the market often have no vibration damping at all. The use of an additional sleeve housing with a damping action comes at the expense of the compact design of pistol-grip power tools. There are also known devices on the market that have a rubber-covered grip for vibration damping. But these do not achieve a satisfactory damping effect.

### Advantages of the Invention

In the power tool according to the invention, an intermediate flange is divided into a bearing bracket element on the drive unit side and a bearing bracket element on the transmission side and these bearing bracket elements are connected to each other by means of a vibration damping device. The vibration damping device here is advantageously integrated into the power tool so that no additional housing parts such as housing casings or a double- or additional-sleeve housing are required. It is therefore possible to take into account the compact design of power tools, in particular those of a pistol-grip design. Moreover, the power tool according to the invention is distinguished by means of a simple assembly.

The vibration damping device itself can be implemented as a function of the available space and can be embodied as a spring element with or without vibration cancellation. Preferably, a compression spring or leaf spring is used as the vibration damping device.

An embodiment in the form of a linkage mechanism is also conceivable;

for example, it is possible to manufacture a connection between the housing shell and the bearing bracket element by means of at least one connecting lever. In this case, use is made of a space in the direction oriented toward an impact mechanism and the vibration damping is implemented by means of a kinematic articulating connection; a relative movement between the housing parts is absorbed by means of linear or rotary articulations.

It is also conceivable to implement the vibration damping in the form of a rubber element that simultaneously functions as a screw connection- and sealing device. Such a vibration damping is provided, for example, in an angle grinder.

Preferably, the bearing bracket elements are situated in separate partial shells of the housing; the drive-side bearing bracket element is connected to the drive-side partial housing shell and the transmission-side bearing bracket element, which serves to accommodate parts of the impact mechanism, is connected to the transmission-side partial housing shell. For example, the bearing bracket elements can be screw-connected to the partial housing shells. The partial housing shells serve to accommodate a drive unit and a transmission unit. In this case, it is advantageous that the vibration damping device is situated between two parts of approximately equal mass. This results in a particularly favorable decoupling of the vibrations generated. The vibration damping device is suitably situated between the bearing bracket elements and between the drive-side and transmission-side partial housing shells and is consequently accommodated in a lubricated, dust-protected region. A seal in relation to the outside can be produced by means of an elastic seal; the seal is preferably embodied so that a damping element is integrated into it. As a result, on the one hand, the partial housing shells are connected to each other and on the other hand, an additional damping action can be simultaneously achieved. The elastic seal is easily visible from outside and can simultaneously serve as an identification means for the user.

The partial housing shells can, for example, be composed of an elastomer. This advantageously implements a fixed stop so that a path for the vibration damping that moves by an amount on the order of a few millimeters, is limited by means of the partial housing shells. It is, however, also possible to use other known materials for the partial housing shells, for example light alloy or plastic such as glass fiber-reinforced polyamide. An axial prestressing can be produced by means of a screw connection or some other kind of connection between the partial housing shells.

Especially in power tools with a pistol-grip design, a design of the gearing is often critical. A gearing on an armature shaft can be load-limiting because often, fewer than 10 teeth are provided. In order to reduce a load on the gearing, in one embodiment of the device according to the invention, a spur gear can be provided on the drive-side bearing bracket element. This advantageously produces a decoupling from the impact mechanism. This arrangement also permits the achievement of an exact axial spacing, which has a positive effect on the service life of the power tool.

It is possible for the drive train to be discontinuous at the engagement of the spline shaft with the spur gear; the spline shaft can be connected by means of a clutch. The clutch is suitably embodied as axially movable. Depending on the product and the vibration amplitude, the clutch can be designed in different ways. It is possible to use bar clutches, disk clutches, bellows clutches, cardan clutches, or other clutches that are able to compensate for a deflection of the vibration damping device. When there are low transmission torques, it is also possible to provide a contactless clutch, for example a magnetic clutch.

On the whole, the power tool according to the invention is able to achieve a particularly favorable decoupling of undesirable vibrations and oscillations. Thanks to the invention's placement of the vibration damping device between the drive-side partial housing shell and the transmission-side partial housing shell, the power tool according to the invention is particularly suitable for use in devices with a pistol-grip design because it does not negatively affect their compact design.

### DRAWINGS

Additional embodiments, aspects, and advantages of the invention also ensue from exemplary embodiments of the invention described below in conjunction with the drawings, independent of how they are combined in the claims and without limitation as to their universal applicability.

FIG. 1 is an external view of a power tool according to the invention;

FIG. 2 is a schematic longitudinal section through one embodiment of the power tool according to the invention;

FIG. 3 is a section through an alternative embodiment; and

FIG. 4 is a detailed view of an alternative kinematic articulating connection.

### DESCRIPTION OF THE EXEMPLARY EMBODIMENTS

The same elements are provided with the same reference numerals in all of the drawings.

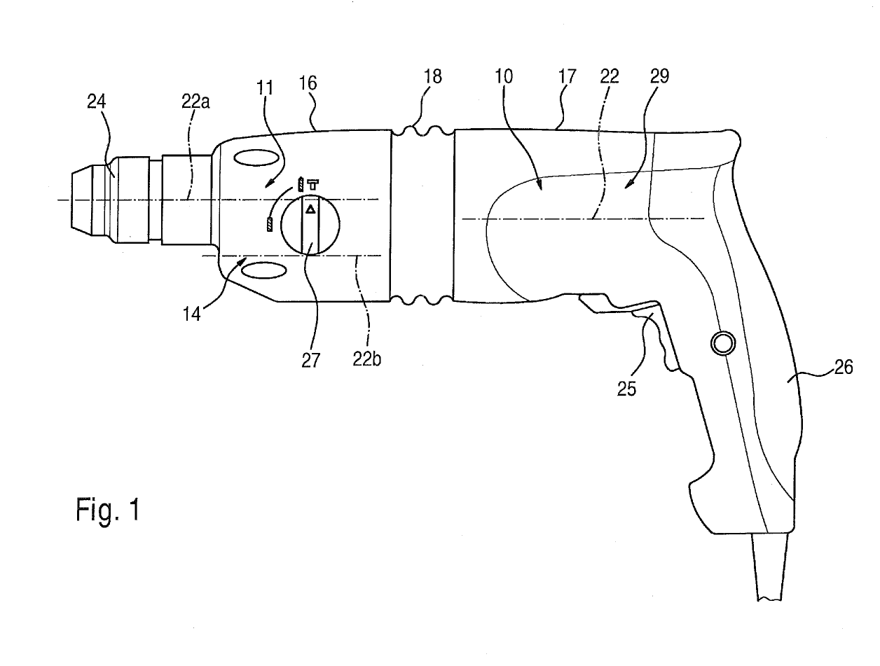

FIG. 1 shows a hand-guided power tool of a pistol-grip design with a grip 26. The power tool usually includes various functional units such as a drive unit 10, e.g. an electric motor, a transmission unit 11, and a unit for securing and supporting a spline shaft 14, which is connected in a force-transmitting fashion to a tool holder embodied in the form of a spindle 24 for accommodating an insert tool that is not visible in FIG. 1. The insert tool, for example a screwdriving bit or drill bit, can be driven in a rotating and/or hammering fashion. The above-mentioned functional units in the pistol-grip design shown here are arranged axially one after another and are coupled to one another by means of frictional and/or form-locking engagement. In this case, a drive axis 22 of an armature shaft 29, an axis 22b of the spline shaft 14, and an axis 22a of a spindle 24 are axially parallel to one another, resulting in a particularly maneuverable embodiment with a favorable transmission of force in a drilling axis. In addition, a grip-enhancing actuation of an on/off switch is provided in the form of a trigger switch 25 in the region of the grip 26. A changeover switch embodied in the form of a rotating knob 27 can be used to switch from a drilling mode to an impact drilling mode where in addition to a rotation, an axial movement of a drilling tool is also enabled.

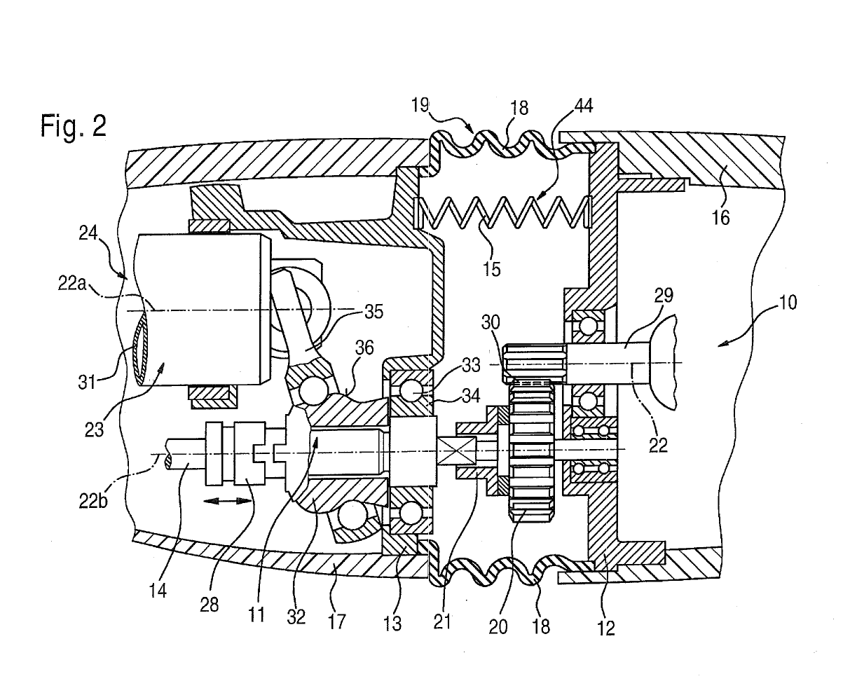

According to the invention, the drive unit 10 and the transmission unit 11 are situated in separate partial housing shells 16, 17 that are connected to each other by means of a vibration damping device 15 that is depicted in FIG. 2. The partial housing shells 16, 17 are connected to each other by means of an elastic seal 18, which seal a space between the partial housing shells 17, 18 and simultaneously have a vibration damping action.

FIG. 2 shows a longitudinal section through an embodiment of the power tool according to the invention. In the power tool according to the invention, an intermediate flange—which is embodied of one piece in conventional designs—is divided into a drive-side bearing bracket element 12 and a transmission-side bearing bracket element 13 that are connected to each other by means of a vibration damping device 15.

The drive-side bearing bracket element 12 is situated in a drive-side partial housing shell 16 and serves to support a spur gear 20.

The transmission side bearing bracket element 13 serves to support a drive train with a drive end fitting 32 and a spline shaft 14 as well as an impact mechanism 23, which are situated in an impact tube or hammer tube 31. The spline shaft 14 is discontinuous in relation to the spur gear 20 and can be connected to it via a clutch 21. In FIG. 2, the clutch 21 is embodied in the form of a sliding gearing; its clutch path is designed to enable a deflection of the vibration damping. The vibration damping primarily occurs by means of the vibration damping device 15, which is embodied as a compression spring and is situated in a grease chamber 44 between the two bearing bracket elements 12, 13. Part of the vibration damping also occurs by means of an elastic seal 18 that seals a space between the two partial housing shells 16, 17. An axial prestressing between the partial housing shells 16, 17 can be produced by means of a screw connection that is not visible in the drawing.

The armature shaft 29 transmits its rotary motion via a gearing 30 to an external gearing of the spur gear 20 operationally connected to the spline shaft 14. The drive end fitting 32 can be supported in the bearing bracket element 13 by means of ball bearings or, as shown in FIG. 2, can be supported on the spline shaft 14. A rotary drive connection between the drive end fitting 32 and the spline shaft 14 can be controlled by means of a changeover switch 28 that permits a selection between an on position and an off position of the impact mechanism 23. The rotary drive connection is implemented by means of a drive element 33 that is radially embedded in a toothed sleeve 34. The drive end fitting 32 of the impact mechanism 23 drives a wobble pin 35 that converts a rotary motion of the drive end fitting 32 into an axial hammering motion. The wobble pin 35 is supported in a conventional fashion on an outside 36 of the drive end fitting 32. Depending on the position of the changeover switch 28 embodied in the form of a sliding sleeve, the drive energy can be disconnected from or transmitted to the impact mechanism 31 in a known fashion. This makes it possible to selectively switch back and forth between different operating modes of the drill, e.g. drilling, impact drilling, and the like.

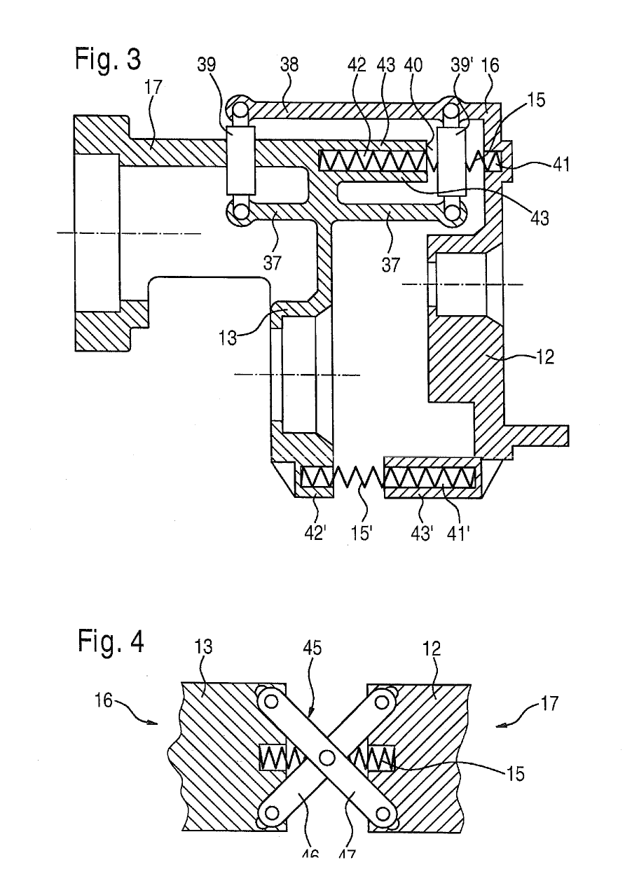

FIG. 3a shows an alternative embodiment of the power tool according to the invention in which a vibration damping device 15, 15′ is embodied in the form of an articulating mechanism. For the sake of simplicity, not all of the elements of a drive unit and the transmission unit are shown here. Two vibration damping devices 15, 15′ embodied in the form of compression springs are provided, each of which is situated between a drive-side bearing bracket element 12 and a transmission-side bearing bracket element 13. The bearing bracket elements 12, 13 are situated in separate partial housing shells 16, 17. A projection 38 at the upper circumference of the drive-side partial housing shell 16 is situated so that it partially embraces the transmission-side partial housing shell 17. The transmission-side bearing bracket element 17 has axial bridge pieces 37, which are connected to the projection 38 of the drive-side partial housing shall 16 by means of transversely oriented connecting levers 39, 39′. In this case, a longitudinal span of the bridge pieces 37 corresponds approximately to a longitudinal span of the projection 38. A vibration damping path of the vibration damping device 15 is limited by a stop 40 that is formed by an end surface of an axial projection 43 oriented toward the drive side. In this instance, the projection 43 constitutes an extension of the partial housing shell 17 in the direction oriented toward the drive side. The vibration damping device 15 embodied in the form of a compression spring is situated in recesses 41, 42; the recess 42 is embodied in the form of an elongated cylinder and is situated in an axially extending projection 43 of the transmission-side bearing bracket element 13. The recess 41 is situated in the drive-side bearing bracket element 12.

A second vibration damping device 15′ embodied in the form of a compression spring is situated at the lower circumference and connects the bearing bracket elements 12, 13. The vibration damping device 15′ is accommodated in recesses 41′, 42′ of the bearing bracket elements 12, 13; the recess 41′ is situated in an axial projection 43′.

FIG. 4 is a detailed view of an alternative vibration damping device 15 embodied in the form of a kinematic articulating connection. By means of two criss-crossing elements 46, 47, a toggle lever 45 with a spring element 15 produces a connection between a drive-side bearing bracket element 12 and a transmission-side bearing bracket element 13. The design essentially corresponds to the one shown in FIG. 1 and is not described in greater detail here in order to avoid repetition. A relative movement between the partial housing shells 16, 17 of the kind that occurs during operation of the power tool, particularly during impact drilling, is absorbed by means of the linear- or rotary linkage comprised by the toggle lever 45. This achieves a vibration damping action.

What is claimed is:

1. A power tool, particularly of a pistol-grip design, having a drive unit (10) and a transmission unit (11), in which at least the drive unit (10) is supported against an intermediate flange and in order to drive a drive train, is provided with a spline shaft (14),
wherein the intermediate flange is divided into a drive-side bearing bracket element (12) and a transmission-side bearing bracket element (13) and these bearing bracket elements are connected to each other by means of a vibration damping device (15).

2. The power tool as recited in claim 1,
wherein the vibration damping device (15) is embodied in the form of a spring element.

3. The power tool as recited in claim 1,
wherein the vibration damping device (15) is embodied in the form of a linkage mechanism.

4. The power tool as recited in claim 1,
wherein the bearing bracket elements (12, 13) are situated in separate partial housing shells (16, 17).

5. The power tool as recited in claim 1,
wherein the partial housing shells (16, 17) are connected to each other by means of an elastic seal (18).

6. The power tool as recited in claim 1,
wherein the seal (18) is embodied so that a damping element (19) is integrated into it.

7. The power tool as recited in claim 1,
wherein it is possible to produce an axial prestressing by means of a screw connection between the partial housing shells (16, 17).

8. The power tool as recited in claim 1,
wherein a spur gear (20) is situated on the drive-side bearing bracket element (12).

9. The power tool as recited in claim 8,
wherein the spline shaft (14) is discontinuous in relation to the spur gear (20).

10. The power tool as recited in claim 8,
wherein the spline shaft (14) is connectable by means of a clutch (21).
